(19) United States
(12) Patent Application Publication
(10) Pub. No.: US 2009/0113491 A1
(43) Pub. Date: Apr. 30, 2009

(54) METHOD AND SYSTEM OF RETRIEVING LOST CONTENT SEGMENTS OF PRIOR BROADCASTED PROGRAMMING AT A USER DEVICE FROM A SERVICE PROVIDER

(76) Inventors: David J. Kuether, Brea, CA (US); Dana J. Greer, Frederick, MD (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(21) Appl. No.: 11/931,450

(22) Filed: Oct. 31, 2007

(51) Int. Cl. H04N 7/20

(52) U.S. Cl. 725/67

(57) ABSTRACT

A method and system includes a user device storing content in a memory, determining a lost content segment exists, generating a request for the lost content segment; communicating the request for the lost content to a service provider, receiving the lost segment and storing the lost content segment in the memory. The system may also include a service provider storing the content therein. The service provider communicates the lost content segment to the user device through a network in response to the request.

### TECHNICAL FIELD

The present disclosure relates generally to communicating content to a user and, more specifically, to communicating lost content segments of prior broadcasted programs or content to a user device.

### BACKGROUND

The statements in this section merely provide background information related to the present disclosure and may not constitute prior art.

Consumers increasingly desire access to various types of content, including music, videos, games, and the like. To meet these needs, content providers are increasingly investigating ways to provide content in a timely manner to consumers.

Satellite distribution systems are one way in which to provide content to various consumers. Pay-per-view and regular broadcasts are available in a satellite system. In a pay-per-view system, access is provided to users for a particular program that is watched by more than one user at the same time. Recording devices in the user devices may be used to store the content for later playback.

In certain situations, a user may desire access to content not available during a regular broadcast or one that is stored within the user device. For example, the user may learn of a broadcasted program of interest without a means to view the past program. Further, providing the user with a program on an individual basis, consumes valuable satellite resources.

Further content may be request to be stored in digital video recoding device. While receiving the content, outages in various portions of the transmission path may leave a portion of the content lost. Content may be lost due to weather conditions, temporary signal irregularities or the like.

### SUMMARY

The present disclosure sets forth a method for utilizing a terrestrial communication network for providing requested lost content segments to a user device. The requested content may be retrieved from a content repository that stores certain broadcasted material for a predetermined amount of time. The material may be requested by the user and sent to the user device. In the case of a satellite content distribution system, another network such as a broadband network may be used to provide the requested content to the user device or set top box. This method reduces the burden on the satellite system although the satellite may be used in certain situations.

In one aspect of the disclosure, a method includes storing content in a memory of the user device, determining a lost content segment exists, generating a request for the lost content segment at the user device, communicating the request for the lost content to a service provider, receiving the lost content segment at the user device from the service provider and storing the lost content segment in the memory of the user device.

In a further aspect of the disclosure, a system includes a user device storing content in a memory, determining a lost content segment exists, generating a request for the lost content segment; communicating the request for the lost content to a service provider, receiving the lost segment and storing the lost content segment in the memory. The system may also include a service provider storing the content therein. The service provider communicates the lost content segment to the user device through in response to the response to the request for the lost content.

In a further aspect of the disclosure, a communication system includes a service provider comprising having a capture system receiving a broadcast transport stream, tagging the broadcasted content stream and storing broadcasted content in a storage system to form previously broadcasted stored content. The system also includes a program retrieval system for retrieving the previously broadcasted stored content. The system may also include a user device requesting content.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic system view of a communication system according to the present disclosure.

FIG. 2 is a detailed block diagrammatic view of a communication system.

FIG. 3 is a representation of a program guide user interface on a display associated with the user device.

FIG. 4 is a screen display of a user interface for confirming a requested program.

FIG. 5 is a block diagrammatic view for selecting a past program from the user device perspective.

FIG. 6 is a flowchart of the method for selecting a past program from the service provider perspective.

FIG. 7 is a flowchart of a method for a method of retrieving lost segments.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

While the following disclosure is made with respect to example DIRECTV® broadcast services and systems, it should be understood that many other delivery systems, such as other satellite delivery systems, are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDs) as described below can be reallocated as desired without departing from the intended scope of the present patent.

Further, while the following disclosure is made with respect to the delivery of content (e.g., television (TV), movies, games, music videos, etc.), it should be understood that the systems and methods disclosed herein could also be used for delivery of any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein. As used herein, the term title or program will be used to refer to, for example, a media content type such as a movie itself and not the name of the movie.

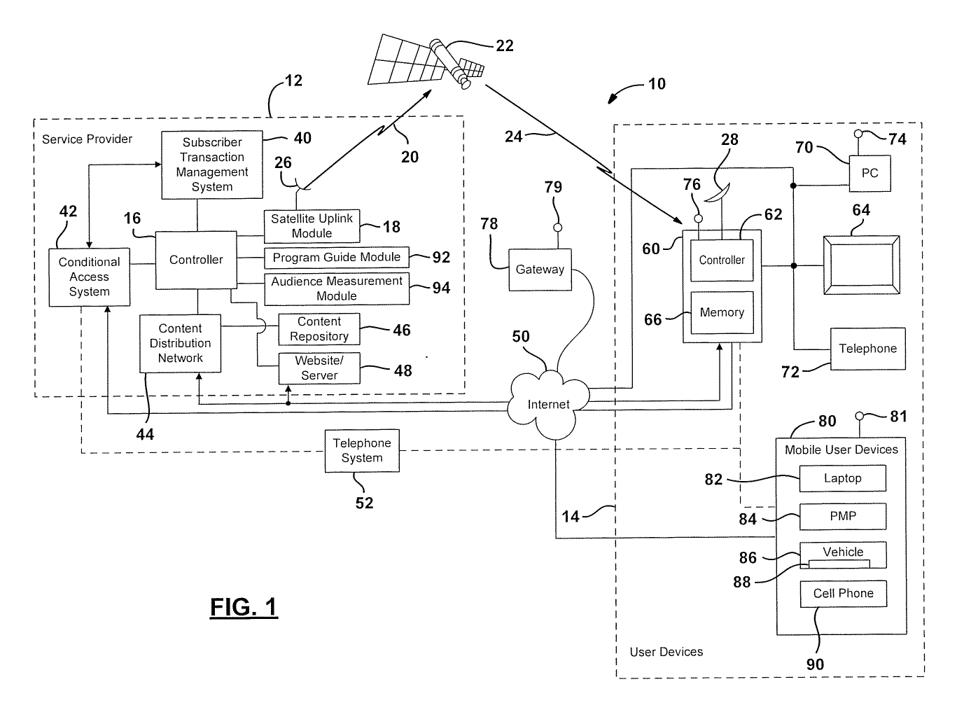

Referring now to FIG. 1, a communication system 10 includes a service provider 12 that communicates content to user devices 14. The service provider 12 may include a controller 16 that is used to control the overall operation of the system. The controller 16 and some of the associated modules and components may be referred to as a head end. A satellite uplink module 18 is used to generate and communicate uplink signals 20 to satellite 22. Satellite 22 generates downlink signals 24 to one or more user devices 14. An antenna 26 associated with the satellite uplink module 18 is used to generate the uplink signals 20. A downlink antenna 28 associated with the user device 14 is used to receive downlink signals. Various types of content or program signals and security information signals, but not limited to security information, encryption-decryption information, digital rights management information, conditional access packets (CAPs), channel or content access lists or rights may be communicated through the communication system 10. It should also be noted that various content may be encrypted based upon a control word (CW) known to the service provider and/or the various user devices. Control word packets (CWPs) may include, among other things, a time stamp and the control word that is used to compute a cryptographic hash of the contents. The control word packets may, from time to time, be transmitted from the service provider through the satellite to the user devices.

The service provider 12 may also include a subscriber transaction management system 40. The subscriber transaction management system (STMS) 40 has the function of a billing system. The STMS 40 keeps track of various transactions and the services to which the various user devices are subscribed to. Billing information and enabling access to a system may be provided through the subscriber transaction management system. Transactions such as requested content may be billed by the system.

A conditional access system 42 may also be coupled to controller 16. The conditional access system 42 generates conditional access packets that may be provided through the satellite or through other communication networks to the user devices 14. The conditional access system 42 may, for example, generate the CAPs described above.

A content distribution network 44 may also be coupled to controller 16. The content distribution network 44 in conjunction with a content repository 46 may be used to provide content through the satellite and through the various other networks. The content distribution network 44, although illustrated entirely within the service provider, may also be outside or partially outside the service provider 12. That is, user devices 14 may be provided access to content from various sources directly once authorized by the service provider. A pay television service may provide content to a user device directly once all the security safeguards have been met. The content repository 46 may be used to generate the current broadcast programming and may also be used to store previously broadcast programming. The previously broadcast programming may be from all channels, selected channels, or popular broadcasts as will be determined below.

A website or server 48 may also be coupled to the controller 16. The website 48 may provide the user devices 14 a way in which to select past programming content for downloading. The use of the various components within the service provider 12 will become evident in the description below.

The conditional access system 42, the content distribution network 44, and the website 48 may all be coupled to the Internet 50. The Internet 50 may be reached through various types of networks, including, but not limited to, a wireless network, a broadband network, a broadband wireless network, a WiFi network, a WiMax network and an optical fiber network.

A telephone system 52 may also be used to communicate between the user device 14 and the service provider 12. The telephone system 52 may include a cellular system that is for the most part wireless or a public switched telephone network (PSTN).

One example of a user device 14 includes a fixed user device such as a set top box 60. The set top box 60 may have various components such as a controller 62 that is used to control the operation of the system and generate and provide the content to the display device 64 such as a television. The set top box 60 may also be referred to as integrated receiver decoder (IRD). The set top box 60 may decode, decompress, depacketize, and demultiplex the content received from the satellite 22. Also, any content received from the Internet 50 may also be decoded, demultiplexed, decompressed and depacketized, if needed. Output drivers, contained within the controller 62, may be used to control the audio and visual function of the display 64.

The set top box 60 may also include a memory 66. The memory 66 may, for example, be a digital video recorder (DVR) such as a hard disk drive. The memory 66 may also be various other types of memory including flash memory. The memory 66 may be used to store content or programs received from the service provider 12 through the satellite 22 or through the Internet 50.

The user device 14 associated with the set top box 60 may also include or be associated with a personal computer 70. The personal computer 70 may be used to provide Internet access for the set top box 60 so that various content may be downloaded from the Internet 50 and from the service provider 12. More specifically, content from the content repository 46 may be provided through the content distribution network 44 through the Internet 50 and stored on the memory 66 of the set top box 60. The personal computer 70 may be used to form the network between the set top box 60 and the Internet 50. The connection between the personal computer 70 and the set top box 60 may be a wired or wireless connection. Of course, if the connection is a wireless connection, a wireless LAN and thus a wireless router may be associated or included within the personal computer 70. An antenna 74 on the PC 70 represents a potential wireless connection to antenna 76 on the set top box 60. The antenna 76 on the set top box 60 may also communicate to an outside wireless router, such as in a WiMax or WiFi system.

A gateway 78 may be used to form access to the Internet in a WiFi or WiMax system through antenna 79. A telephone 72 may also be used to communicate with the service provider 12. The telephone 72 may be used to initiate the past programming download service by the user who communicates directly with an operator or a menu system at the service provider 12. Part of the information received from the satellite 22 may include a program guide that includes various selections of past programming therein.

The user devices 14 may also include mobile user devices 80. The mobile user devices 80 may include the functionality described above with respect to the set top box 60 such as a controller, a memory, an antenna 81 for communicating with the satellite and communicating through the wireless network. Although one antenna is shown, more than one may be used to receive the wireless network signals and the satellite signals. The antenna 81 is shown generally. The antenna may be incorporated within each device. However, mobile devices may communicate wirelessly through the Internet 50, through a telephone system 52, such as a cellular system, through the Internet, a WiFi, WiMax, other type of wireless systems or more than one wireless system. The wireless communications may communicate content or programs as well as provide callbacks from the mobile user devices 80 to the service provider 12. The call backs may include a request for content. Confirmation signals may also use the Internet 50 or the telephone system 52 as will be further described below. It should also be noted that a different network may be used to communicate program content and other communications between the service provider 12 and the user devices 14 including the mobile user devices 80.

The mobile user devices 80 may include many different devices, including a laptop computer 82, a portable media player 84, a vehicle such as an automotive vehicle that includes a mobile set top box 88 and a cell phone 90. The cell phone 90 may include such devices as a personal digital assistant. It is important that all of the mobile user devices 80 include some form of wireless communication system to receive content from the service provider 12.

The service provider 12 may include a program guide module 92. The program guide module 92 is used to determine the contents of a program guide. The program guide module 92 provides the user devices 14 with information regarding current and future programming. This is the typical function of the program guide modules in the DIRECTV® system. Information in the program guide include channels, programming information, times, titles, previews, and the like. A content or material identification (ID) such as a number or an alpha-numeric identifier may be used to identify the particular program. The content ID may correspond to IDs of content stored in the content repository. The program guide module 92, in the present disclosure, also provides information to the user devices relative to past programming that is available from the service provider. The past programming is stored within the content repository 46. The past programming may include all the programming broadcast within the last certain amount of time. The certain amount of time may be two weeks, a month, a week, a few days, or the like. All of the broadcasted programs for all of the channels may be made available. However, only certain numbers of channels may have their information stored. Also, portions of the channels or popular portions of the channels may be stored without the entire day's worth of programming for a particular channel. The program guide module 92, through the guidance of the controller 16, formulates the program guide and transmits the program guide information through the satellite 22 through the satellite uplink module 18 to the user devices 14. Updates to the program guide may also be broadcast. The program guide module 92 may consist of packetized information that is spaced from time to time throughout the broadcasted programming.

An audience measurement module 94 coupled to the controller 16 may also be provided within the service provider 12. The audience measurement module 94 may be used to measure the popularity of a particular program. Popularity information from the audience measurement module 94 may be used to perform various functions including determining through which network a particular requested program may be broadcast. For example, if the audience measurement module determines that the particular program is being requested often, the satellite 22 may be used to broadcast a program to various users. If the audience measurement module 94 determines the program is not very popular, the Internet or a broadband network may be used to distribute the program.

The audience measurement module 94 may receive information from the subscriber transaction management system 40 to count the number of times a particular program has been requested. The similar information may also be retrieved from the content repository 46 and the content distribution network 44 by counting the number of times the content has been transmitted. The actions and consequences of the audience measurement module will be evident below.

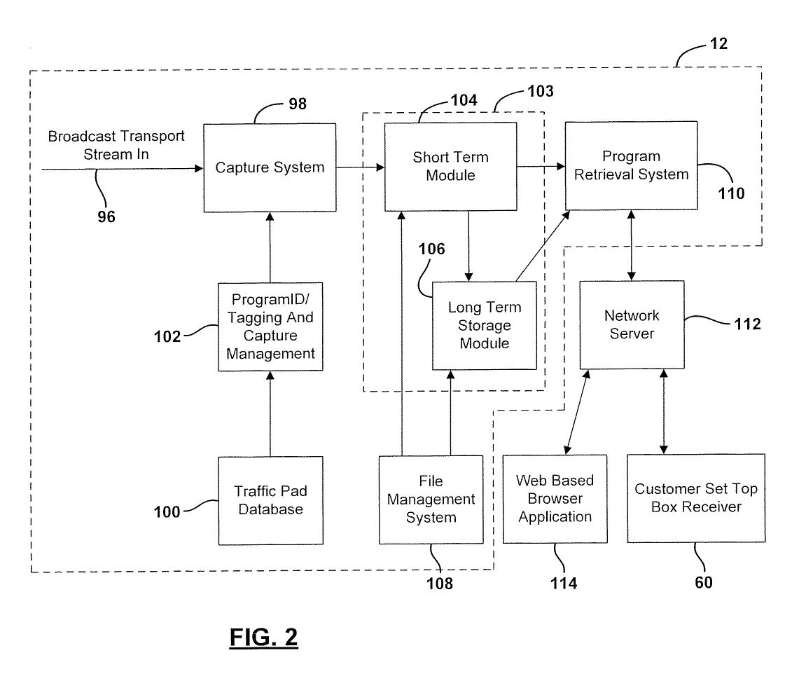

Referring now to FIG. 2, a detailed block diagrammatic view of the service provider 12 is illustrated. In this embodiment, a broadcast stream 96 is developed for broadcasting the content through the satellite uplink module 18. The broadcast stream 96 is communicated through a capture system 98. The capture system 98 is in communication with a traffic program-associated data (PAD) database 100 and a program ID/tagging and capture management module 102. The capture system 98 may be a computer such as a personal computer or blade server having a bitstream capture card installed therein. The bitstream capture card may tune to a signal for a transponder so that the actual bitstream for the transponder, channel or program may be extracted.

Program-associated data may be inserted into the bitstream through the tagging and capture management module 102. The program-associated data may be obtained from the traffic database 100. The program identification and tagging may be placed into a header of the bitstream for identification of the specific program or program portions. Capture may be performed of an entire program or program portions and spliced together during playback.

Once the bitstream has been captured and tagged in the capture system 98, the tagged content may be stored in a storage system 103 that includes a short-term storage module 104. A long-term storage module 106 may also be included in the storage system 103. The storage system 103 may be the content repository 46 illustrated in FIG. 1. However, the storage system may be an independent storage system as well. The short-term storage module 104, the long-term storage module 106 may be in communication with a file management system 108. The file management system 108 may manage the short-term storage module 104, the long-term storage module 106 to move content therebetween and remove content from storage. Movement may be based upon a date when the content was stored. For example, if a certain content has not been accessed for a certain period of time, the content stored in one of the storage modules may be removed. Content that has a high number of requests may be moved from the short-term storage module 104 to the long-term storage module 106 where access may continue to be obtained.

It should be noted that when storing various content such as programs, movies, or the like, guide data and null packets may be stripped and thus not stored within the storage system. The file management system 108 may be used to track the location of the various programming stored therein so that it may be retrieved upon request.

A program-retrieval system 110 may be in communication with the short-term module 104. The long-term storage module 106 may also be in communication with the program-retrieval system 110. The program retrieval system may receive a request for a program from the network server 112. The request may originate from the set top box receiver 60 for a web-based browser application 114. A validation process may be performed that provides that the set top box receiver 60 is a valid account and that the receiver is capable of storing the size of the content. The program-retrieval system retrieves the information and location from the file management system 108. The network server 112 may receive the content and push the content to the set top box receiver 60.

The set top box receiver 60 may communicate with the network server 112 through various communication technologies including a broadband network, a wireless terrestrial network or a wired communication network. Content may be delivered by way of the satellite or by way of the terrestrial, broadband, wireless or wired networks.

A web-based browser application 114 may also be in communication with the network server 112. The web-based browser application may also be used to request that content be provided to the set top box.

In the above example, an entire program such as a movie or television program may be requested from the service provider 12. An entire series or season or parts thereof of a program may also be requested. In addition, a portion of a content program may also be requested. A portion of the content program may correspond to a lost content segment. A lost content segment may be formed when a memory device such as a DVR is recording a particular content upon the request in the set top box receiver. During reception, an error may occur causing a portion of the entire content less than the entire content or a lost content segment to be formed. The loss may be caused by many sources in the distribution stream, including problems at the service provider, problems at the satellite, or problems at the user device. Heavy cloud cover or rain may result in a temporarily lost signal. Errors within the transponder system may also cause a lost content segment. Problems in the uplinking system may also cause a lost content segment. If the content is transmitted through the Internet 50 of FIG. 1, temporary losses of connection, lost packets, or the like may cause a lost content segment. A lost content segment may be easily identified from the set top box receiver due to a missing portion of the content. The lost content may also correspond to missing audio or video portions. Missing segments may be easily identified since the headers will not be consecutive from various portions of the content. Other ways to identify a lost content segment are to determine if time stamps are missing, whether a searching for satellite signal message (SFSS) comes up during the recording, or determining if a partial recording tag was generated. Starting and stopping points of lost segments may be determined by determining a point prior to and just after the above-mentioned events. The customer may also request a re-recording of the entire content.

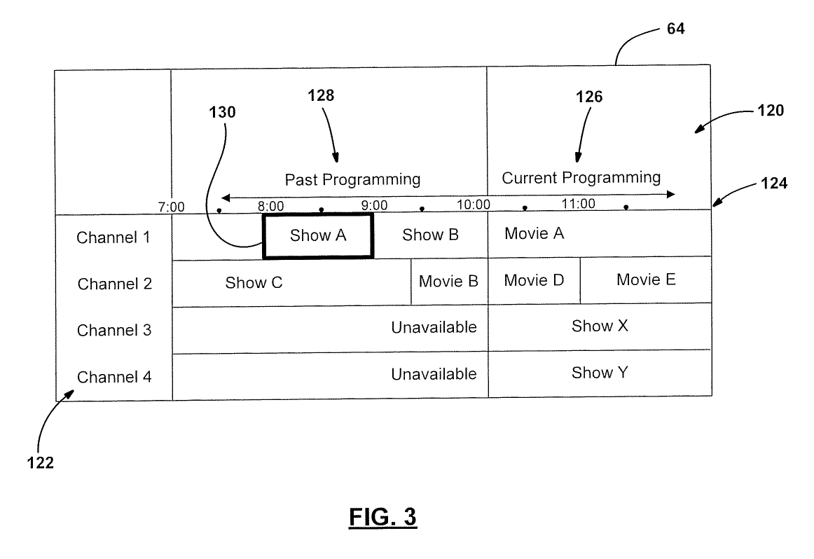

Referring now to FIG. 3, a display 64 having a graphical user interface such as a program guide 120 is illustrated. The program guide includes channel identifiers 122 and programming elements 124. The programming elements 124, not all of which are shown, may include various types of information including a title, rating, a brief description, the actors, and the like. As is illustrated, current broadcasting 126 is illustrated together with past programming 128. Determining past and current programming is relative to a particular point in time, e.g., the current time. As mentioned above, not all of the information for all of the programs may be available in the past programming portion 128. A selection may be made by moving a screen cursor that highlights various shows desired to be downloaded. For example, show A illustrated as element 130 has a highlighted box. For a selection to take place, the user interacts by way of a remote control or buttons on the set top box to move to and select the desired element. It should also be noted that all of the past programming may not be displayed to the user.

The program guide 120 and the elements 124 therein may be scrolled by the user. For example, the program guide may be scrolled in the reverse direction (to the left in FIG. 2). Scrolling may take place corresponding to the time period for which the programming has been saved. That is, if two weeks of available past broadcasted programming is available and stored within the content repository, scrolling to the left may take place for only two weeks. It should be noted that various types of scrolling, including horizontal and vertical scrolling, may take place.

Searching using a graphical user interface generated at the set top box may also take place by the user. For example, searching based on title, actor, key words in the title or description may take place in conjunction with the remote control or other user interface. After searching, a selection may be made. Selections may also be made at a website using a program guide.

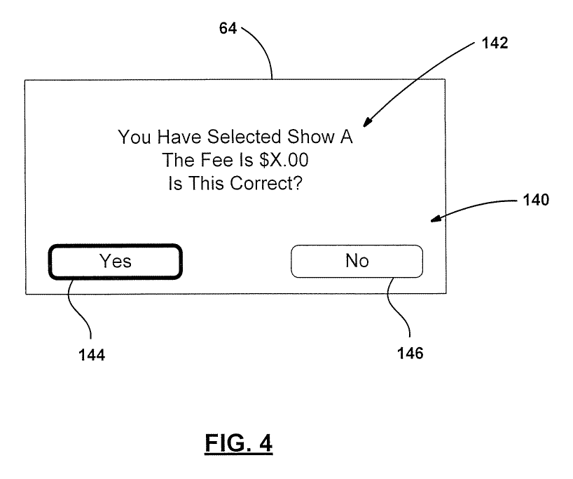

Referring now to FIG. 4, once a selection on display 64 has taken place in FIG. 2, a confirmation screen 140 may be displayed. The confirmation screen 140 may generate a message 142 that includes a YES box 144 and a NO box 146. The message may include that “YOU HAVE SELECTED SHOW A. THE FEE IS $X.00. IS THIS CORRECT?” The user may then confirm the selections by selecting the YES box 144 which is bolded in FIG. 3. The YES box 144 may be selected by a push button on the remote or on the set top box itself. A confirmation signal is sent to the service provider to initiate the transfer of the program from the service provider to the user devices. A purchase can be verified via a phone line through a callback on a regular basis from the set top box. The purchase could also be verified using a broadband connection.

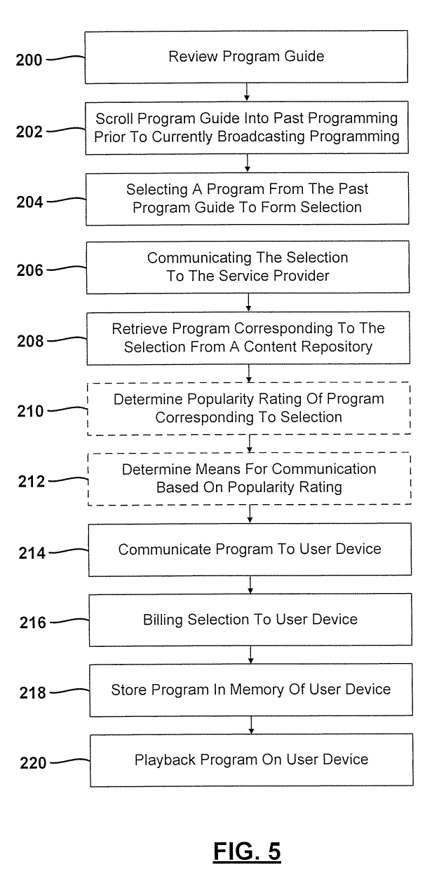

Referring now to FIG. 5, a method of selecting a program from the perspective of the user is illustrated. In step 200, the program guide is reviewed by the user. It should also be noted that step 200 may be performed on the set top box or on a service provider website. That is, a user may logon to a user website and select a desired program from a program guide displayed on the selection. In this manner, remote access and control may be provided to the user. For example, if the user is at a workplace or another location having Internet access, the service provider website may be reached and logged into by the particular user. A selection may, therefore, be selected and communicated to the user device. In this manner, the particular program may be communicated to the user device so that it is available when the user returns to the device. As mentioned above, searching may also be used to find possible selections.

In step 202, the program guide may be scrolled into past programming which is prior to the currently broadcasting program. The programming guide for past programming may be limited to only those available for downloading. Thus, the program guide on the website or on the display associated with the user device may be reduced in size. In step 204, a program from the past programming guide is selected to form a selection. As described in FIG. 2, the selection may be performed by using the remote or other user interface. In step 208, the program is retrieved that corresponds to the selection from a content repository. The selection may generate a content identifier that is used to select a corresponding program or content from the content repository.

In step 210, a popularity rating of the program corresponding to the selection may be determined. As mentioned above, the audience measurement module 94 of FIG. 1 may be used to determine the popularity rating of the particular program. In step 212, a means for communicating the program may be determined based upon the popularity rating. This was mentioned above in the description of FIG. 1. For example, a popular program may be communicated through the satellite while a less popular title may be communicated through a terrestrial network. Both steps 210 and 212 are optional steps.

In step 214, the program corresponding to the selection is communicated to the user device. As mentioned above, the program may be communicated through a different network than the selection signal is communicated. Although, both may use the same. The program may be communicated through a wireless network, a broadband network, a WiFi network, a WiMax network, a cellular network, a wireless broadband network, or through a wired broadband network. A satellite network may also be used to communicate the program. In step 216, the selection is billed to the account associated with the user device. This may be performed at the subscriber transaction management system 40 illustrated in FIG. 1.

In step 218, the program may be stored in the memory of the user device. In the case of a set top box, the program may be stored in a digital video recorder. The program may also be played back in real time as received. However, it is more likely that the program is played back from a memory in a commercial embodiment.

In step 220, the program is played back on the user device. That is, depending on the type of program, the user device may be used to generate audio, audio and video, gaming control, or the like. The audio signals may be communicated through a speaker while the video signals are displayed on the display 64 illustrated in FIG. 1.

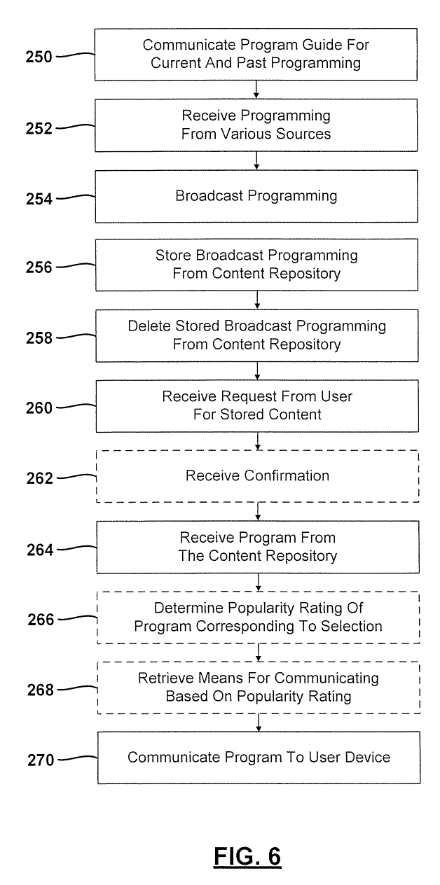

Referring now to FIG. 6, a method of operating from the perspective of the service provider 12 is set forth. In step 250, a program guide including current and past programming is communicated to one of the user devices 15. The program guide may be formulated from information stored in the content repository 46 in FIG. 1. The program guide may be communicated through various means including satellite, telephone, and various types of broadband and Internet connections. This connection may be wired or wireless and include a WiFi network, WiMax network, or the like.

In step 252, programming is received from various sources including from DVDs, tapes, the satellite or optical fibers and are stored in the content repository 46. In step 254, the programming is broadcast through the satellite 22. In step 256, the broadcast programming is stored in the content repository. As mentioned above, the programming that is broadcast may be selectively stored in the content repository. That is, only popular programs or those deemed potentially popular may be stored. Also, programming from certain channels may not be stored at all.

In step 258, stored broadcast programming may be deleted from the content repository. This may be under the control of the controller 16. The broadcast programming that is stored in the content repository may be date-stamped so that only a pre-determined amount of previously broadcast programming is retained or stored in the content repository. The date stamp may, for example, be the time and date of the broadcast. For example, a two-week retention window may be used by the content repository 46 for removing any older stored previously broadcasted program. Thus, any stored broadcasted programming greater than two weeks old may be deleted from the system or removed from being available (removed from the program guide). It should be noted that various times may be set forth. Also, various retention times associated with various programs or channels may also be set forth. That is, different channels and different programs may have different retention times within the content repository 46. Popular titles could be maintained longer than less popular titles.

Further, availability or retention windows may also be established to allow user devices to see what is available and still allow them sufficient time to download the material. For example, if two weeks of material is maintained, the actual publish time may be two weeks plus some fixed time to allocate the program to be communicated to a user device. The extra time may be fixed or variable depending on the length of a particular content. To summarize, the content may actually be available for a predetermined amount of time after it is removed from an “available” content list or the program guide. Such a feature may allow the system time to service various requests and, therefore, increase customer satisfaction.

In step 260, requests are received at the service provider for particular stored content through a network. In step 262, an optional step of receiving a confirmation from the user device may be performed. That is, both a request and a confirmation may be required for transferring a program to the user device. The confirmation and request may also take place only at the user device and, thus, they may be combined into one signal received at the user device.

In step 264, the program corresponding to the selected content is retrieved from the content repository.

In step 266, optional steps corresponding to steps 210 and 212 may be performed. In step 266, a popularity rating may be determined for the particular program. In step 268, a means for communicating based upon the popularity of the program may be determined. This may entail choosing a network. In step 268, based upon the popularity rating, a network for communicating may be determined. As mentioned above in step 212, various types of networks may be used based upon the popularity including wired, wireless, terrestrial, and satellite. In step 270, the program is communicated to the user device using the selected communication means.

The present disclosure allows a user to request content that was heretofore otherwise not available. In prior systems, a user would identify various programming desirable to be downloaded prior to broadcast and thereafter, during the broadcast, storing the content on a local memory device. The present disclosure allows prior broadcasted programming to be received at various times after the program is broadcast. This provides a significant benefit to the user so they may access more content.

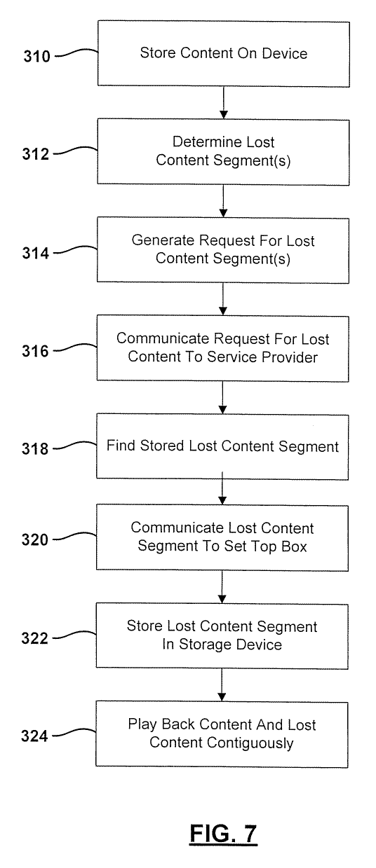

Referring now to FIG. 7, a method for obtaining lost content segments is provided. In step 310, content that has been requested from the service provider is stored on the device. The content may be requested through a broadband system or through a terrestrial system. When receiving the content, lost segments may be formed in the content. The lost segment corresponds to a portion or less than the entire piece of content. In step 312, a lost content segment or segments is determined. The lost content segments may be determined in various ways, including looking for lost signals such as audio, video or both upon receiving the content signals, reviewing a discontinuity of content headers, or the like.

In step 314, a request for a lost content segment is generated by the set top box or other user device. In step 316, the request for lost content is communicated to the service provider. The communication may take place through a network such as the Internet or through a public-switched telephone network. The communication may be a wireless communication or a wired communication through a terrestrial network.

In step 318, a stored lost content is found by the service provider 12. The file management system 108 of FIG. 2 may be used to locate the lost content segment. It should be noted that only the lost content segment may be provided and not the full or entire content. In step 320, the lost content segment may be communicated to the set top box. The communication may take place through a broadband network, the Internet 50 of FIG. 1, through a public-switched telephone network or through the satellite. The lost content segment does not have to be communicated through the same network that the original content was provided. For example, the content may be communicated through a satellite and the lost content segment through a terrestrial broadband network. The request may also be communicated through a broadband network or telephone network.

In step 322, the lost content segment is stored in the storage device. The storage device may include a digital video recorder or other types of volatile or non-volatile memory.

In step 324, the content may be played back with the lost content contiguously. That is, the lost content may be played back contiguously within the content so that no noticeable gaps are provided to the content user. The controller 62 of the user device 60 illustrated in FIG. 1 may be used to play back the content contiguously.

It should be noted that the system is preferably automatic. That is, as content is being stored within the system, or after the content has been stored within the system, the request for a lost content segment may be generated when lost content segments are included within the content stored within the memory device. By the time the content is viewed the lost control segments may be stored so that playback becomes uninterrupted by lost content segments.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method comprising:
storing content in a memory of the user device;
determining a lost content segment exists;
generating a request for the lost content segment at the user device;
communicating the request for the lost content to a service provider;
receiving the lost content segment at the user device from the service provider; and
storing the lost content segment in the memory of the user device.

2. A method as recited in claim 1 wherein the memory of the user device comprises a digital video recorder.

3. A method as recited in claim 1 wherein determining a lost content exists, comprises determining the lost content exists from program associated data, the presence of a searching for satellite signal, a partial recording tag or missing time stamp.

4. A method as recited in claim 1 wherein determining a lost content segment exists, comprises determining the lost content segment exists during storing content in the memory.

5. A method as recited in claim 1 further comprising communicating content to a user device through a satellite network and storing the content at the service provider.

6. A method as recited in claim 1 further comprising communicating content to a user device through a wired terrestrial network.

7. A method as recited in claim 1 further comprising communicating content to a user device through a wireless terrestrial network.

8. A method as recited in claim 1 wherein communicating the request comprises communicating the request through a broadband network.

9. A method as recited in claim 1 wherein communicating the request comprises communicating the request through a public switched telephone network.

10. A method as recited in claim 1 further comprising prior to receiving, communicating the lost segment from the service provider to the user device.

11. A method as recited in claim 10 wherein communicating the lost segment comprises communicating the lost content segment through a satellite.

12. A method as recited in claim 10 wherein communicating the lost segment comprises communicating the lost content segment through a broadband network.

13. A method as recited in claim 10 wherein communicating the lost segment comprises communicating the lost content segment through a terrestrial wireless network.

14. A method as recited in claim 10 further comprising communicating content to a user device through a satellite network and wherein communicating the lost segment comprises communicating the lost content segment through a broadband network.

15. A system comprising:
a user device storing content in a memory, determining a lost content segment exists, generating a request for the lost content segment, communicating the request for the lost content to a service provider, receiving the lost segment and storing the lost content segment in the memory.

16. A system as recited in claim 15 further comprising a service provider storing the content therein, said service provider communicating the lost content segment to the user device through in response to the response to the request for the lost content.

17. A system as recited in claim 16 wherein the user device communicates the request through a first network and the service provider communicates the lost content through the first network.

18. A system as recited in claim 17 wherein the first network comprises a broadband network

19. A system as recited in claim 16 wherein the user device communicates the request through a first network and the service provider communicates the lost content through a second network different than the first network.

20. A system as recited in claim 19 wherein the first network comprises a broadband network and the second network comprises a satellite network.

21. A system as recited in claim 15 further comprising a satellite network communicating the content to the user device.

22. A system comprising
a service provider comprising
a capture system receiving a broadcast transport stream corresponding to content, tagging the broadcasted content stream and storing the content in a storage system to form previously broadcasted stored content; and
a program retrieval system for retrieving the previously broadcasted stored content.

23. A system as recited in claim 22 further comprising a user device in communication with the service provider, said user device determining a lost content segment an requesting the lost content segment from the service device.

24. A system as recited in claim 22 wherein said service provider communicates the lost content segment from the storage system to the user device.

25. A system as recited in claim 22 wherein the storage system comprises short term storage and a long term storage module and a file management system for moving files from the short term storage module to the long term storage module.
